(19) United States
(12) Patent Application Publication
(10) Pub. No.: US 2012/0281858 A1
(43) Pub. Date: Nov. 8, 2012

(54) METHOD AND APPARATUS FOR TRANSMISSION OF SOUND WAVES WITH HIGH LOCALIZATION of SOUND PRODUCTION

(76) Inventor: Menachem Margaliot, Bnei Brak (IL)

(21) Appl. No.: 13/463,025

(22) Filed: May 3, 2012

Related U.S. Application Data
(60) Provisional application No. 61/481,801, filed on May 3, 2011.

(51) Int. Cl. H04R 1/40

(52) U.S. Cl. 381/97

(57) ABSTRACT

A system for the production of localized audible sound, including a source of voltage oscillations in the ultrasonic frequency range, at a reference frequency. The voltage source is connected to a first ultrasonic transducer, emitting a first beam of ultrasonic waves (the reference beam) in a relatively narrow beam, in a desired direction. The same voltage source is connected to a phase shifter, feeding a second ultrasonic transducer from which an ultrasonic wave is emitted, of the same frequency and intensity as the reference beam, but phase shifted relative to it.

### FIELD OF THE INVENTION

The present invention relates generally to the directional transmission of sound waves, producing sonic information in a limited region of space, using small aperture speakers.

### BACKGROUND OF THE INVENTION

It is a general rule in the physics of wave emission, that when high directionality of a beam of waves is desired, the aperture from which these waves are emitted must be large compared to the wavelength of the waves.

To be more specific: the dispersion angle of a wave beam emitted from a circular aperture of diameter D is given by:

θ=2.44λ/D 1)

with θ being the beam dispersion angle (in radians) and λ—the wavelength.

To obtain high directionality (namely: a small θ), for a given wavelength λ, one must thus use a large D source.

With specific regard to sound waves, one must consider a minimal frequency of about 100 Hz (this is the lower frequency limit for most medium quality sound systems).

This acoustic frequency corresponds to a wavelength given by:

λ=V/f 2)

λ being the above wavelength, V—sound velocity in air (˜330 m/Sec), and f—the frequency (Hz).

Eq. 2 thus yields a wavelength of ˜3.3 m for a 100 Hz sound wave. This, in turn, leads (from eq. 1) to a diameter D of ˜8 meters for the loudspeaker aperture, even when a moderate directionality (i.e. θ=1 radian ≈57⁰) is desired. However, loudspeakers of such large diameters are impractical.

Directional production of sound utilizing amplitude modulation of ultrasonic waves has been proposed (US published patent application US2003003552A1—process and system for directional acoustic propagation, Kolano, et al. 2003). This method however produces sound all along its path, and as the loss of energy from the ultrasonic beam is non-linear in beam intensity (at higher intensities, relatively more energy is lost), the amplitude modulation becomes distorted along the propagation path.

Another problem with this approach is that the sound is produced all along the beam path, and thus, if it is desired that sound be produced only at a limited region (for example; in the near proximity of a specific listener only), this approach fails.

### SUMMARY OF THE INVENTION

The present invention seeks to provide a method and apparatus for emitting highly directional sound waves, carrying information at audio frequencies, from much smaller loudspeakers, and reproducing the audio frequency information.

An additional aim of the present invention, without limitation, is to produce the audio acoustic waves at a limited region in space, thus providing sound only to the person(s) present in said region. In contrast to the prior art, the present invention comprises phase modulation of the ultrasonic wave, and hence, the energy loss along the waves propagation path does not distort the audio information carried by the ultrasonic wave, as is described more in detail hereinbelow.

Still an additional aim of the present invention, without limitation, is to enable the automatic directing of the sound thus produced, to the proximity of the ear(s) of the intended listener, by means of a video camera equipped with face feature detection software. This last feature enables automatic tracking of the ears location as the listener moves his head, and adjusting the location of the sound production region accordingly.

Some features of the invention include, without limitation:

A system for the production of directional sound comprising a source of voltage oscillations in the ultrasonic frequency range, at a reference frequency. The ultrasonic frequency range may be greater than or equal to 20 kHz. There is an input for the audio signal.

The system may include an electronic circuit producing a second ultrasonic signal at the same frequency of the reference frequency, but with its phase shifted in relation to the abovementioned reference frequency. The phase shift may be in the range 0-180°, where the size of the shift is determined by the relative intensity of the audio signal: when the audio signal is maximal in intensity, the phase shift is set to zero, while when the audio signal is very weak, the phase shift is set to 180°, with corresponding intermediate phase shifts for intermediate audio intensities. This electronic circuit applies the phase shifting function at a repetition rate which equals the desired audio frequency.

The system may include two ultrasonic transducers, capable of transforming the electrical signals to ultrasound pressure waves in air. The first of these transducers is connected to the reference frequency output of the system, while the second is connected to the phase shifted output of the system. The transducers may be capable of producing directional beams of ultrasound in air, due to their sizes being considerably larger than the wavelengths (in air) of the ultrasonic waves produced.

The system may include devices for positioning the ultrasonic transducers so as to cause the ultrasonic beams thus produced, to intersect at a desired location in space (the audible region), wherein the directing devices are controllable by the operator of the system, thus enabling variations in the intersection location.

The system may include more than one set of reference and phase shifted units, enabling stereo personal listening. The system may include separate control of the system operator on the intensities of the reference and phase shifted transducers.

The system may include one source of reference waves, but two or more sets of phase shifted waves, with the single reference beam having a large angular dispersion, thus producing two or more intersection regions.

### BRIEF DESCRIPTION OF THE DRAWINGS

FIG. 1 is a simplified schematic illustration of a system for the production of directional sound, constructed and operative in accordance with an embodiment of the present invention. Shown in FIG. 1 are:

1. A source oscillator, producing simultaneously a reference ultrasonic oscillation, and a second ultrasonic oscillation at the same frequency, which is phase shifted in relation to the above mentioned reference frequency, the phase shifting being modulated at the desired audio frequency.

2. A reference frequency transducer (ultrasonic loudspeaker)

3. Beam modulated by being phase shifted versus the reference oscillations.

4. The intersection region of the two beams

5. Source of audio modulation

FIG. 2 is a similar to FIG. 1, except for having two (3A, 3B) beams modulated by being phase shifted versus the reference oscillations, instead of just one as in FIG. 1.

### DETAILED DESCRIPTION OF EMBODIMENTS

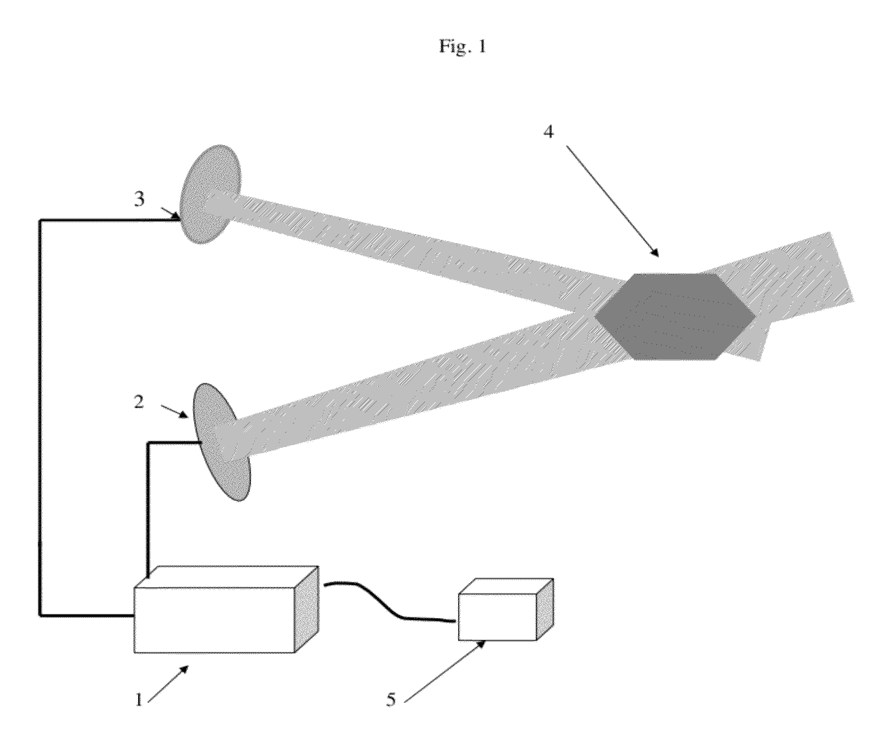

Reference is now made to FIG. 1, which illustrates a system for the production of directional sound, constructed and operative in accordance with an embodiment of the present invention.

The directional audio loudspeaker of the present invention may include two (2) ultrasonic emitters. The first of these emits an ultrasonic wave at a fixed frequency, henceforth referred to as the reference frequency (or frequency A).

The second of these sources emits an ultrasonic wave at the same frequency as the above reference frequency, but its phase is shifted versus the phase of the reference frequency where the frequency of shifting is the desired audio frequency and the magnitude of phase shifting is dependent on the relative intensity of audio signal. The intensity of the waves emitted from these two emitters is set to be equal and controllable by the user.

Since the ultrasonic waves have a high frequency (well above 20 kHz), their wavelengths are short (in comparison to the low audio frequency). Assuming a minimal ultrasound frequency of ˜20 kHz, the corresponding wavelength (according to eq. 2) is 1.65 cm only. According to eq. 1, a 1 radian angular dispersion will be attained from ultrasonic emitters with a diameter of ˜4 cm only. Using higher frequencies will produce a smaller dispersion from the same diameter or enable the use of a smaller diameter ultrasonic emitter.

The two ultrasonic emitters are positioned with their beams intersecting at the region of interest (the location of the listener).

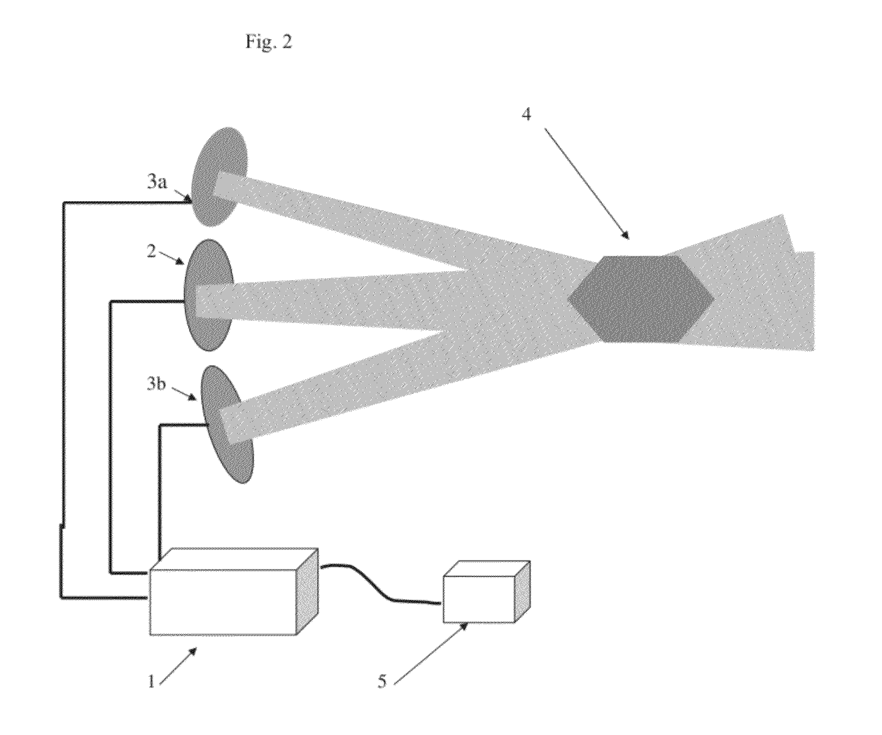

When the two ultrasonic beams intersect, a summing of the waves occurs. (In the embodiment of FIG. 2, the second and third transducers 3A and 3B are so directed as to have the same distance from the transducers to the point of intersection.)

The first and second waves combine at the point of intersection to form one wave, the amplitude of which is dependent on the phase shift: when this phase shift is zero, the combined (A+B) amplitude is at maximum, while when this phase shift is 180°, the combination of second and third waves produces zero amplitude.

As can be appreciated by those acquainted with wave theory, phase shifting intermediate between those two extremum conditions can thus produce the full range of combined amplitudes, from maximal value (B+C=A) to zero.

The frequency at which phase shifting is applied, is the desired audio frequency, while the amplitude is determined by the magnitude of the phase shift, thus both correct frequency and amplitude are attained at the desired region in space, where the ear of the listener is located.

The directionality is thus obtained by the very short ultrasonic wavelengths, while the audio signal is produced only at the region of interest, where the two waves (reference and phase shifted) intersect.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. A system comprising:
a first ultrasonic emitter operative to emit an ultrasonic wave at a fixed frequency, referred to as a reference frequency; and
a second ultrasonic emitter operative to emit another ultrasonic wave at said reference frequency, wherein said other ultrasonic wave is phase shifted versus a phase of said reference frequency and a frequency of said phase shifting is a desired audio frequency and a magnitude of said phase shifting is dependent on a relative intensity of audio signal.

2. A system according to claim 1, wherein an intensity of said ultrasonic waves emitted from said first and said second ultrasonic emitters is set to be equal.

3. A system according to claim 1, wherein an intensity of said ultrasonic waves emitted from said first and said second ultrasonic emitters is controllable by a user.

4. A system according to claim 1, wherein said ultrasonic waves have a frequency above 20 kHz.

5. A system according to claim 1, wherein wavelengths of said ultrasonic waves are short in comparison to a frequency of said audio signal.

6. A system according to claim 1, wherein said first and said second ultrasonic emitters are positioned with their beams intersecting at a region of interest.

7. A system according to claim 1, wherein said first and said second ultrasonic emitters are positioned with their beams intersecting at a location of a listener.

8. A system according to claim 1, wherein waves emitted from said first and said second ultrasonic emitters combine at a point of intersection to form one wave, the amplitude of said one wave being dependent on the phase shift, wherein when the phase shift is zero, the combined amplitude is at maximum, while when the phase shift is 180°, the combined amplitude is zero.
